(19) United States
(12) Patent Application Publication
(10) Pub. No.: US 2004/0167767 A1
(43) Pub. Date: Aug. 26, 2004

(54) Method and system for extracting sports highlights from audio signals

(76) Inventors: Ziyou Xiong, Urbana, IL (US); Regunathan Radhakrishnan, Arlington, MA (US); Ajay Divakaran, Burlington, MA (US)

Correspondence Address: Patent Department, Mitsubishi Electric Research Laboratories, Inc., 201 Broadway, Cambridge, MA, 02139, US

(21) Appl. No.: 10/374,017

(22) Filed: Feb. 25, 2003

(51) Int. Cl. G06F 17/20

(52) U.S. Cl. 704/1

(57) ABSTRACT

A method extracts highlights from an audio signal of a sporting event. The audio signal can be part of a sports videos. First, sets of features are extracted from the audio signal. The sets of features are classified according to the following classes: applause, cheering, ball hit, music, speech and speech with music. Adjacent sets of identically classified features are grouped. Portions of the audio signal corresponding to groups of features classified as applause or cheering and with a duration greater than a predetermined threshold are selected as highlights.

### FIELD OF THE INVENTION

The invention relates generally to the field of multimedia content analysis, and more particularly to audio-based content summarization.

### BACKGROUND OF THE INVENTION

Video summarization can be defined generally as a process that generates a compact or abstract representation of a video, see Hanjalic et al., “An Integrated Scheme for Automated Video Abstraction Based on Unsupervised Cluster-Validity Analysis,” IEEE Trans. On Circuits and Systems for Video Technology, Vol. 9, No. 8, December 1999. Previous work on video summarization has mostly emphasized clustering based on color features, because color features are easy to extract and robust to noise. The summary itself consists of either a summary of the entire video or a concatenated set of interesting segments of the video.

Of special interest to the present invention is using sound recognition for sports highlight extraction from multimedia content. Unlike speech recognition, which deals primarily with the specific problem of recognizing spoken words, sound recognition deals with the more general problem of identifying and classifying audio signals. For example, in videos of sporting events, it may be desired to identify spectator applause, cheering, impact of a bat on a ball, excited speech, background noise or music. Sound recognition is not concerned with deciphering audio content, but rather with classifying the audio content. By classifying the audio content in this way, it is possible to locate interesting highlights from a sporting event. Thus, it would be possible to skim rapidly through the video, only playing back a small portion starting where an interesting highlight begins.

Prior art systems using audio content classification for highlight extraction focus on a single sport for analysis. For baseball, Rui et al. have detected announcer's excited speech and ball-bat impact sound using directional template matching based on the audio signal only, see, “Automatically extracting highlights for TV baseball programs,” Eighth ACM International Conference on Multimedia, pp. 105-115, 2000. For golf, Hsu has used Mel-scale Frequency Cepstrum Coefficients(MFCC) as audio features and a multi-variate Gaussian distribution as a classifier to detect golf club-ball impact, see, “Speech audio project report,” Class Project Report, Columbia University, 2000.

Audio Features

Most audio features described so far have fallen into three categories: energy-based, spectrum-based, and perceptual-based. Examples of the energy-based category are short time energy used by Saunders, “Real-time discrimination of broadcast speech/music,” Proceedings of ICASSP 96, Vol. II, pp. 993-996, May 1996, and 4Hz modulation energy used by Scheirer et al., “Construction and evaluation of a robust multifeature speech/music discriminator,” Proc. ICASSP-97, April 1997, for speech/music classification.

Examples of the spectrum-based category are roll-off of the spectrum, spectral flux, MFCC by Scheirer et al, above, and linear spectrum pair, band periodicity by Lu et al., “Content-based audio segmentation using support vector machines,” Proceeding of ICME 2001, pp. 956-959, 2001.

Examples of the perceptual-based category include pitch estimated by Zhang et al., “Content-based classification and retrieval of audio,” Proceeding of the SPIE 43^{rd} Annual Conference on Advanced Signal Processing Algorithms, Architectures and Implementations, Vol. VIII, 1998, for discriminating more classes such as songs and speech over music. Further, gamma-tone filter features simulate the human auditory system, see, e.g., Srinivasan et al, “Towards robust features for classifying audio in the cuevideo system,” Proceedings of the Seventh ACM Intl' Conf. on Multimedia'99, pp. 393-400, 1999.

Computational constraints of set-top and personal video devices cannot support a completely distinct highlight extraction method for each of a number of different sporting events. Therefore, what is desired is a single system and method for extracting highlights from multiple types of sport videos.

### SUMMARY OF THE INVENTION

A method extracts highlights from an audio signal of a sporting event. The audio signal can be part of a sports video.

First, sets of features are extracted from the audio signal. The sets of features are classified according to the following classes: applause, cheering, ball hit, music, speech and speech with music.

Adjacent sets of identically classified features are grouped.

Portions of the audio signal corresponding to groups of features classified as applause or cheering and with a duration greater than a predetermined threshold are selected as highlights.

### BRIEF DESCRIPTION OF THE DRAWINGS

FIG. 1 is a block diagram of a sports highlight extraction system and method according to the invention.

### DETAILED DESCRIPTION OF THE PREFERRED EMBODIMENT

System Structure

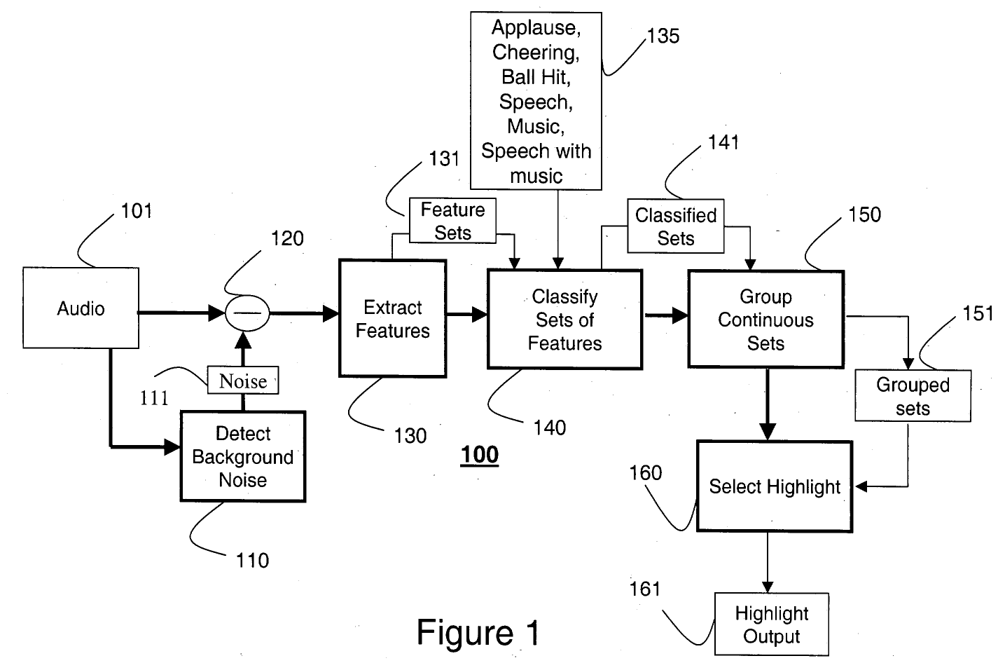

FIG. 1 shows a system and method 100 for extracting highlights from an audio signal of a sports video according to our invention. The system 100 includes a background noise detector 110, a feature extractor 130, a classifier 140, a grouper 150 and a highlight selector 160. The classifier uses six audio classes 135, i.e., applause, cheering, ball hit, speech, music, speech with music. Although, the invention is described with respect to a sports video, it should be understood, that invention can also be applied to just an audio signal, e.g., a radio broadcast of a sporting events.

System Operation

First, background noise 111 is detected 110 and subtracted 120 from an input audio signal 101. Sets of features 131 are extracted 130 from the input audio 101, as described below. The sets of features are classified 140 according to the six classes 135. Adjacent sets of features 141 identically classified are grouped 150.

Highlights 161 are selected 160 from the grouped sets 151.

Background Noise Detection

We use an adaptive background noise detection scheme 110 in order to subtract 120 as much background noise 111 from the input audio signal 101 before classification 140 as possible. Background noise 111 levels vary according to which type of sport is presented for highlight extraction.

Our multiple sport highlight extractor can operate on videos of different sporting events, e.g., golf, baseball, football, soccer, etc. We have observed that golf spectators are usually quiet, baseball fans make noise occasionally during the games, and soccer fans sing and chant almost throughout the entire game. Therefore, simply detecting silence is inappropriate.

Our segments of audio signal have a duration of 0.5 seconds. As a preprocessing step, we select 1/100 of all segments in the audio track of a game and use the average energy and average magnitude of the selected segments as threshold to declare a background noise segment. Silent segments can also be detected using this approach.

Feature Extraction

In our feature extraction, the audio signal 101 is divided into overlapping frames of 30 ms duration, with 10 ms overlap for a pair of consecutive frames. Each frame is multiplied by a Hamming-window function:

wi=0:5; 0:46 £ cos(2¼i=N); 0·i<N where N is a number of samples in a window.

Lower and upper boundaries of the frequency bands for MPEG-7 features are 62.5 Hz and 8 kHz over a spectrum of 7 octaves. Each subband spans a quarter of an octave so there are 28 subbands. Those frequencies that are below 62.5 Hz are grouped into an extra subband. After normalization of the 29 log subband energies, a 30-element vector represents the frame. This vector is then projected onto the first ten principal components of the PCA space of every class.

MPEG-7 Audio Features for Generalized Sound Recognition

Recently the MPEG-7 international standard has adopted new, dimension-reduced, de-correlated spectral features for general sound classification. MPEG-7 features are dimension-reduced spectral vectors obtained using a linear transformation of a spectrogram. They are the basis projection features based on principal component analysis (PCA) and an optional independent component analysis (ICA). For each audio class, PCA is performed on a normalized log subband energy of all the audio frames from all training examples in a class. The frequency bands are decided using the logarithmic scale, e.g., an octave scale.

Mel-Scale Frequency Cepstrum Coefficients (MFCC)

MFCC are based on discrete cosine transform (DCT). They are defined as:

$${c}_{n} = \sqrt{\frac{2}{K}} {\sum }_{k = 1}^{K} ( log {S}_{k} \times cos [ n ( k - \frac{1}{2} ) \frac{π}{K} ] ) , n = 1 , … , L , \qquad ( 1 )$$

where K is the number of the subbands and L is the desired length of the cepstrum. Usually L<<K for the dimension reduction purpose. ^{S′}^{ₖ}^{s, 0≦K<K} are the filter bank energy after passing the kth triangular band-pass filter. The frequency bands are decided using the Mel-frequency scale, i.e., linear scale below 1 kHz and logarithmic scale above 1 kHz.

Audio Classification

The basic unit for classification 140 is a 0.5 ms segment of the audio signal with 0.125 seconds overlap. The segment is classified according to one of the six classes 135.

In the audio domain, there are common events relating to highlights across different sports. After an interesting event, e.g., a long drive in golf, a hit in baseball or an exciting soccer attack, the audience shows appreciation by applauding or even loud cheering.

A ball hit segment preceded or followed by cheering or applause can indicate an interesting highlight. The duration of applause or cheering is longer when an event is more interesting, e.g., a home-run in baseball.

There are also common events relating to uninteresting segments in sports videos, e.g., commercials, that are mainly composed of music, speech or speech with music segments. Segments classified as music, speech, and speech and music can be filtered out as non-highlights.

In the preferred embodiment, we use entropic prior hidden Markov model (EP-HMM) as the classifier.

Entropic Prior HMM

We denote X as the model parameters, and O as the observation. When there is no bias toward any prior model i, that is we assume ^{P(λ}^{ᵢ}^{)=P(λ}^{ⱼ}^{), ∀i,j} then a maximize a posteriori (MAP) test is equivalent to a maximum likelihood (ML) test: O is classified to be of class j if ^{P(0|λ}^{ⱼ}^{)≧P(0|λ}^{ᵢ}^{), ∀i} due to the Bayes rule:

$$P ( λ \vert O ) = \frac{P ( O \vert λ ) P ( λ )}{P ( O )} .$$

However, if we assume the following biased probabilistic model

$$P ( λ \vert O ) = \frac{P ( O \vert λ ) {P}_{e} ( λ )}{P ( O )} ,$$

where ^{P}^{ₑ}^{(λ)=}^{ₑ}^{-H(P(λ))} and H denotes entropy, i.e., the smaller the entropy, the more likely the parameter, then we use the MAP test and compare

$$\frac{P ( O \vert {λ}_{i} ) {ⅇ}^{- H ( P ( {λ}_{i} ) )}}{P ( O \vert {λ}_{j} ) {ⅇ}^{- H ( P ( {λ}_{j} ) )}}$$

with Equation 1 to see whether O should be classified as class i orj. A modification to the process of updating the parameters of the ML-HMM for EP-HMM is a maximization step in the expectation-maximization (EM) algorithm. The additional complexity is minimal. The segments are then grouped according to continuity of identical class segments.

Grouping

Because of classification error and the existence of other sound classes not represented by the classes 135, a post-processing scheme can be provided to clean up the classification results. For this, we make use of the following observations: applause and cheering are usually of long duration, e.g., spanning over several continuous segments.

Adjacent segments that are classified as applause or cheering respectively are grouped accordingly. Grouped segments longer than a predetermined percentage of the longest grouped applause or cheering segment are declared to be applause or cheering. This percentage, which can be user selectable, can depend on the overall length of all of the highlights in the video, e.g., 33%.

Final Presentation

Applause or cheering usually takes place after some interesting play, either a good put in golf, baseball hit or a goal in soccer. The correct classification and identification of these segments allows the extraction of highlights due to this strong correlation.

Based on when the applause or cheering starts, we output a pair of time-stamps identifying video frames before and after this starting point. Once again, the total span of frames that will include the highlight can be user-selected. These time-stamps can then be used to display the highlights of the video using random-access capabilities of most state-of-the-art video players.

Training and Testing Data Set

The system is trained with training data obtained from audio clips collected from television broadcasts golf, baseball and soccer events. The durations of the clips vary from around 0.5 seconds, e.g., for ball hit, to more than 10 seconds, e.g., for music segments. The total duration of the training data is approximately 1.2 hours.

Test data include the audio tracks of four games including two golf matches of about two hours, a three hour baseball game, and a two hour soccer game. The total duration of the test data is about nine hours. The background noise level of the first golf match is low, and high for the second match because it took place on a rainy day. The soccer game has high background noise. The audio signals are all mono-channel, 16 bit per sample, with a sampling rate of 16 kHz.

Results

It is subjective what the true highlights are in baseball, golf or soccer games. Instead we look at the classification accuracy of the applause and cheering which is more objective.

We exploit the strong correlation between these events and the highlights. A high classification accuracy of these events leads to good highlight extraction. The applause or cheering portions of the four games are hand-labeled. Pairs of onset and offset time stamps of these events are identified. They are the ground truth for us to compare with the classification results.

Those 0.5 second-long segments that are continuously classified as applause or cheering respectively are grouped into clusters. These clusters are then checked to see whether they are true applause or cheering segments, by determining if they are over the selected percentage of the longest applause or cheering cluster. The results are summarized in Table 1 and Table 2.

TABLE 1

| | [A] | [B] | [C] | [D] | [E] |
|---|---|---|---|---|---|
| [1] | 58 | 47 | 35 | 60.3% | 74.5% |
| [2] | 42 | 94 | 24 | 57.1% | 25.5% |
| [3] | 82 | 290 | 72 | 87.8% | 24.8% |
| [4] | 54 | 145 | 22 | 40.7% | 15.1% |

Table 1 shows rows of classification results with post-processing of the four games. [1]: golf game 1; [2]: golf game 2; [3] baseball game; [4] soccer game. The columns indicate [A]: Number of Applause and Cheering clusters in a ground Truth Set; [B]: Number of Applause and Cheering clusters by Classifiers; [C]: Number of true Applause and Cheering clusters by Classifiers; [D]: Precision

$$\frac{[ C ]}{[ A ]} ;$$

[E] Recall

$$\frac{[ C ]}{[ B ]} .$$

TABLE 2

| | [A] | [B] | [C] | [D] | [E] |
|---|---|---|---|---|---|
| [1] | 58 | 151 | 35 | 60.3% | 23.1% |
| [2] | 42 | 512 | 24 | 57.1% | 4.7% |
| [3] | 82 | 1392 | 72 | 87.8% | 5.2% |
| [4] | 54 | 1393 | 22 | 40.7% | 1.6% |

Table 2 shows classification results without clustering.

In Table 1 and Table 2, we have used “precision-recall” to evaluate the performance. Precision is the percentage of events, e.g., applause or cheering, that are correctly classified. Recall is the percentage of classified events that are indeed correctly classified.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for extracting highlights from an audio signal of a sporting event, comprising:
extracting sets of features from an audio signal of a sporting event;
classifying the sets of the extracted features according to classes selected from the group consisting of applause, cheering, ball hit, music, speech and speech with music;
grouping adjacent sets of identically classified features; and
selecting as highlights portions of the audio signal corresponding to groups of features classified as applause or cheering and with a duration greater than a predetermined threshold.

2. The method of claim 1, further comprising;
filtering out sets of features classified as music, speech, or speech with music.

3. The method of claim 1 further comprising:
outputting a first time-stamp a first predetermined time before a beginning of a selected highlight; and
outputting a second time-stamp a second predetermined time after the beginning of a selected highlight.

4. The method of claim 3 wherein the audio signal is part of a video, and further comprising:
associating frames of the video with the first and second time-stamps.

5. The method of claim 1 further comprising:
subtracting background noise from the audio signal.

6. The method of claim 1 wherein the features are MPEG-7 audio features.

7. The method of claim 1 wherein the features are MPEG-7 audio features.

8. The method of claim 1 wherein the predetermined threshold depends on an overall length of all of the selected highlights.

9. The method of claim 1 further comprising:
correlating a groups of features classified as ball hit with the groups of features classified as applause or cheering.

10. A system for extracting highlights from an audio signal of a sporting event, comprising:
means for extracting sets of features from an audio signal of a sporting event;
means for classifying the sets of the extracted features according to classes selected from the group consisting of applause, cheering, ball hit, music, speech and speech with music;
means for grouping adjacent sets of identically classified features; and
means for selecting as highlights portions of the audio signal corresponding to groups of features classified as applause or cheering and with a duration greater than a predetermined threshold.
